(19) United States
(12) Patent Application Publication
(10) Pub. No.: US 2011/0051403 A1
(43) Pub. Date: Mar. 3, 2011

(54) FLUORESCENT LIGHTING FIXTURE

(75) Inventor: Randy Owen, Republic, WA (US)

(73) Assignee: Industrial Light & Energy, Inc., Snohomish, WA (US)

(21) Appl. No.: 12/691,424

(22) Filed: Jan. 21, 2010

Related U.S. Application Data
(63) Continuation-in-part of application No. 29/342,912, filed on Sep. 2, 2009, now Pat. No. D611643.

(51) Int. Cl. F21L 4/00; F21V 7/00; H01J 9/24

(52) U.S. Cl. 362/157; 362/217.05; 445/23

(57) ABSTRACT

A lamp fixture includes a housing situated along a housing principal axis. The housing has a first housing end and a second housing end which are situated in opposed relation along the housing principle axis. A polycarbonate lens tube encompasses the housing about the housing principle axis and transmits light emanating from the at least one tubular fluorescent lamp. The lens tube is open at first and second tube ends. The first and second tubular ends are situated in opposed relation along the housing principle axis. A first endcap joins the first tube end to the first housing end. A second endcap joins the second tube end to the second housing end. When endcaps join the tubular lens to the housing, the resulting unit provides a light fixture for the at least one fluorescent tubular lamp.

### RELATED APPLICATIONS

This application is a Continuation-In-Part of the Design patent application having Ser. No. 29/342,912 and filed on Sep. 2, 2009. That Design Application is fully incorporated herein by this reference and the Applicant claims priority to that application.

### FIELD OF THE INVENTION

This invention relates generally to lighting fixtures and, more specifically, to fluorescent lighting fixtures.

### BACKGROUND OF THE INVENTION

The lumen is defined such that the peak of the photopic vision curve has a luminous efficacy of 683 lumens/watt. Yet, the lumen is not, by itself, a good indicator of the quality of a cast light for illuminating a working environment. Humans have scotopic vision and photopic vision and some wavelengths are more favorable to scotopic vision and some wavelengths are more favorable to photopic vision.

Photopic vision is vision using the cone cells in the retina of the eye. Photopic vision is color vision and has high resolution (optics of the eye and any corrective eyewear permitting). The cone cells are most concentrated in the central portion of the retina.

Scotopic vision is vision using the rod cells in the retina. Scotopic vision is black-and-white and is low resolution. Since the central degree or two of the retina lacks rod cells and the general central area of the retina is low on rod cells, scotopic vision is lacking in central vision. Scotopic vision is apparent when illumination levels are too dim for photopic vision to work at all. see in black and white with low resolution, once you dark-adapt.

When mesopic vision is effect, scotopic vision mostly results in a sense of “overall brightness”. Two scenes equally illuminated in terms of photopic units will look unequally illuminated if one has light more favorable to scotopic vision than the other does. Similarly, one may find it far easier to work under light that is more favorable to scotopic vision.

One effect of scotopic-vs-photopic vision may be what types of light fixtures are better for illuminating a work place such as a desk or bench. Studies indicate scotopic vision has some effect at lighting levels frequently found indoors. Scotopic vision adds a sensation of “bright illumination” which makes the eye's pupils constrict and thus, exploits the greater depth of field that comes with constricted pupils, i.e. such lighting makes things come into focus or stay in focus more easily.

Fluorescent lighting has been found to be very customizable in its luminescence based upon selections from among the various available phosphors. A glass tube coated on the inside with a fluorescent substance that gives off light when mercury vapor in the tube is acted upon by a stream of electrons from the cathode, the fluorescent light allows for selectively composing the output along the visible spectrum. Such lamps are known generally as spectrally enhanced lighting.

A report released by the U.S. Department of Energy documents field test evaluation results of spectrally enhanced lighting technology used in three buildings. Spectrally Enhanced Lighting is a lighting design technique that can save 20% more energy than commonly used T8 with electronic ballasted fluorescent lighting systems. Properly designed systems can achieve 50% savings over T12 and magnetically ballasted lighting systems. These savings are achieved by using naturally occurring visual efficiencies gained through the use of lighting whose color spectrum is more like daylight than most commonly used light sources, which are more yellow in appearance than Spectrally Enhanced Lighting. The visual benefits from the enhanced spectrum include higher levels of brightness perception and visual acuity when measured at the same footcandle level. These visual benefits were discovered during the 1990's in U.S. Department of Energy (DOE) research studies, which demonstrated these effects as a naturally occurring result of the eye's response to shifting the color of light to include more blue in the spectrum.

Shifting the color in fluorescent lamps to make a light source that enhances visual acuity of illuminated objects is easily accomplished through mixing the phosphors within the lamps to achieve a higher Correlated Color Temperatures (CCT's) and Color Rendering Index (CRI). These shifts generally result in a higher Scotopic to Photopic ratio, or S/P value, which is used in the mathematical formulae to evaluate the visual effects. For instance, a light source with a 5000K CCT and 82 CRI will have a higher S/P ratio than a 3500 CCT, 75 CRI fluorescent lamp, and will therefore provide better visual acuity under the conditions of equal measured lighting levels.

Energy savings are obtained by using lamps that have a higher S/P ratio, and then determining the setting for the light levels that will result in equal visual acuity. For instance, if the visual benefit from the enhanced spectrum is 20%, the lighting levels could be reduced by 20% to obtain the same reading ability, which therefore results in a 20% savings in energy.

Thus, based upon the selection of phosphors, a near perfect orchestration of constituent frequencies of light can be composed by the addition of different type of illuminance based on the relative sensitivity of the rods to different wavelengths of light called the rod spectral sensitivity function or the scotopic response function. For the purpose of this discussion, fluorescent light, suitably composed, approaches an optimum lighting

Often, however, people select incandescent droplights in spite of the heat they generate (often burning the person working with them) and to poor spectrum they emanate for illuminating work. Incandescent droplights are portable and durable so they are selected for work in spite of their failure to efficiently illuminate the work in question. Additionally, bringing the light into close proximity to the work assures that parts adjacent to the work will reflect glare into the person's eyes making seeing the work a tiresome task. A far better solution would include a selected fluorescent tube or tubes in a durable and portable fixture that could be mounted overhead issuing sufficient light in a controlled spectrum to easily illuminate a work piece. Such a light fixture is missing from the art.

### BRIEF DESCRIPTION OF THE DRAWINGS

Preferred and alternative examples of the present invention are described in detail below with reference to the following drawings:

FIG. 1A is an exploded view of a portable fluorescent light fixture for use over work surfaces;

FIG. 1B is a perspective view of the portable fluorescent light fixture;

FIG. 2 is an orthogonal view of the portable fluorescent light fixture for use over work surfaces;

FIG. 3A is a perspective view of an LED track installed upon a reflector for preserving night vision; and

FIG. 3B is a detailed cross-section of the reflector showing the positioning of the LED strip at the apex of the reflector.

### DETAILED DESCRIPTION OF THE PREFERRED EMBODIMENT

A work space can be a very demanding environment where both work and worker may be injured in the absence of suitable lighting. Lighting is one of the major elements affecting efficiency, productivity and comfort in the workplace. The goal in shop illumination should be to have the task brighter than the surroundings.

Quality of illumination pertains to the distribution of brightness in the visual environment. The ability to see detail depends upon a difference in brightness between the detail and its background, but eyes function most comfortably and efficiently when the difference is kept within a certain range. Glare, diffusion, direction, uniformity are further factors in lending to visual acuity in the workspace. Tasks performed over long periods of time and demanding discernment of fine details require illumination of high quality.

Glare is defined as any brightness within the field of vision which causes reduced visibility and discomfort, annoyance and eye fatigue. The two types of glare are direct and reflected. Direct glare is the result of a source of illumination within the field of view, whether that source is artificial of nature. Incandescent lamps, even those with frosted surfaces tend to be very directed small light sources. When used as drop lights, they promote rather than prevent glare and can be very tiring to the eyes. Fluorescent lamps, because of their longer dimension, tend to bathe a work place with even and soft light.

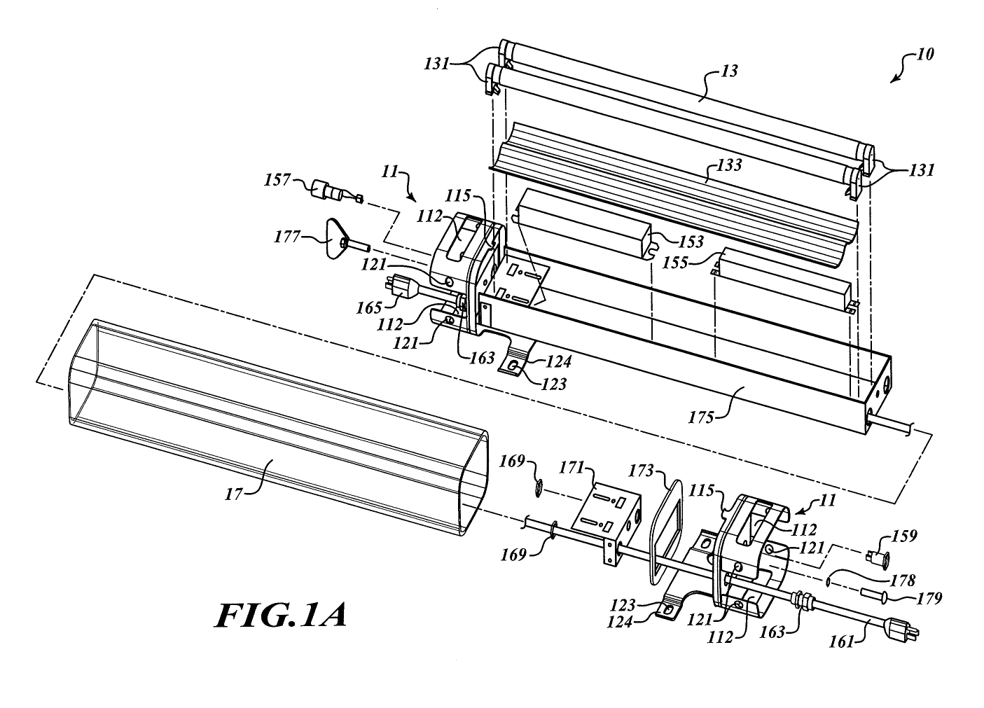

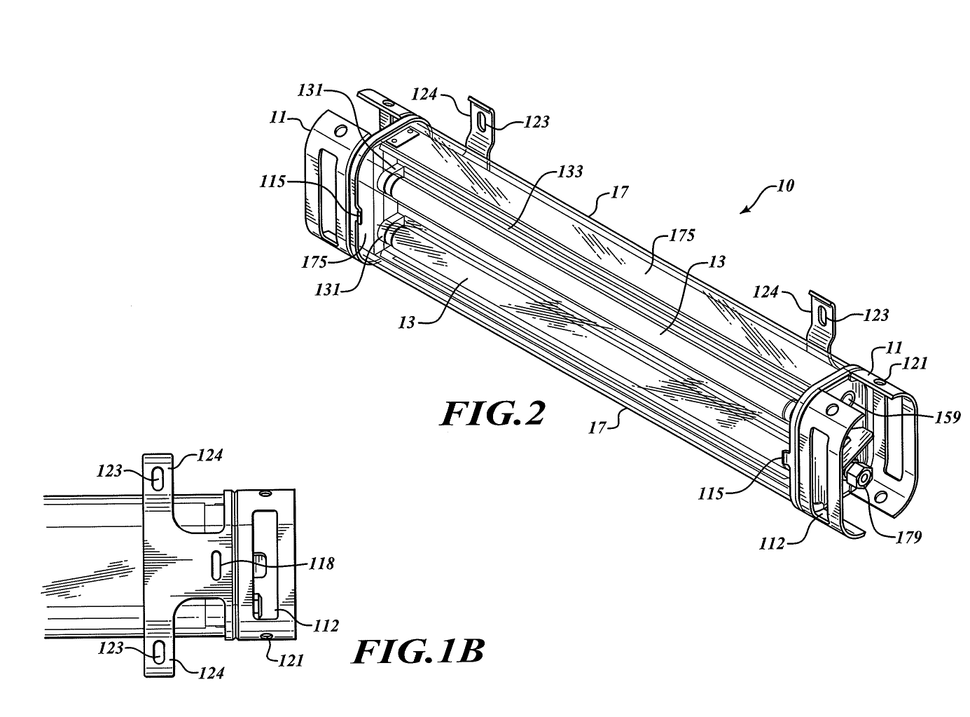

Referring to FIGS. 1A, 1B and 2, a light fixture 10 is described that can exploit Spectrally Enhanced Lighting to its fullest potential but is not limited in its application to Spectrally Enhanced Lighting. The light fixture 10 is configured to accept Spectrally Enhanced Lighting fluorescent lamps but can readily be scaled to accept standard T5, T8, T9, T10 and T12 tubes. Because the light fixture 10 uses electronic ballasts 155, it is much more economical than older standard ballast fixtures. The light fixture is durable, compact, and efficient, meeting the needs for placement in a modern safe work environment.

Fluorescent lamp tubes 13 are negative differential resistance devices, so as more current flows through them, the electrical resistance of the fluorescent lamp drops, allowing even more current to flow. Connected directly to a constant-voltage mains power supply, a fluorescent lamp tube 13 would rapidly self-destruct due to the uncontrolled current flow. To prevent this, fluorescent lamp tubes 13 must used in series with an auxiliary device, an electronic ballast 155, to regulate the current flow through the tube 13.

The simplest ballast for alternating current use is a series coil or choke, consisting of a winding on a laminated magnetic core. The inductance of this winding limits the flow of AC current. This type is still used, for example, in 120 volt operated desk lamps using relatively short lamps. Conventional ballasts are rated for the size of lamp and power frequency. Where the supplied voltage is insufficient to start long fluorescent lamps, the ballast is often a step-up autotransformer with substantial leakage inductance (so as to limit the current flow). Either form of inductive ballast may also include a capacitor for power factor correction. These are relatively inefficient and are not well-suited for use in the inventive fixture.

Electronic ballasts 155 employ transistors to alter mains voltage frequency into high-frequency AC while also regulating the current flow in the lamp. These ballasts 155 take advantage of the higher efficacy of lamps operated with higher-frequency current. Depending upon the capacitance and the quality of constant-current pulse-width-modulation, this can largely eliminate modulation at 100 or 120 Hz.

While the light fixture 10 does not rely upon any particular circuit, a preferred embodiment of the light fixture 10 exploits an electronic ballast that includes backup battery such as that taught in U.S. Pat. No. 7,057,351, to Kuo which is incorporated by this reference. Any suitable circuit configuration exploiting the electronic ballast 155, however, will suffice. A housing 175 is configured to contain and fix the ballast 155 and the backup battery 153 within to ruggedize the light fixture 10 against movement induced by shock to the light fixture 10. As shown in FIG. 1A, the backup battery 153 is selected to provide suitable DC voltage and to fit within the profile of the housing 175. A pair of housing endcaps 171 are affixed on opposing ends of the housing 175 complete its integrity and to lend strength to the housing as a structural beam within the lamp fixture 10.

The lamp tubes 13 are energized through conductors within sockets 131 affixed to the housing 175 at positions selected in accord with the type of bulb the lamp fixture 10 is to receive. Nothing within this specification should suggest that types of lamps cannot be advantageously mixed. With suitable electronic ballast 155, the lamp fixture 10 can be suitably modified in length, depth, and width to accommodate gangs of lamps that are selected to optimize the quality and quantity of light emanating from the energized lamp fixture 10.

The Illuminating Engineering Society of North America (IESNA, 2004) recommends maximum luminance ratios of 1:3 or 3:1 between central task materials and the immediatevisual surround (approximately 25° visual angle, centered at fixation) and 1:10 or 10:1 between task materials and more remote surroundings. Similar guidelines are provided by the American National Standards Institute (ANSI, 1993). Wolska and Switula (1999) reviewed other relevant standards for office lighting (see also CIBSE, 1993; Harris, Duffy, Smith, & Stephanidis, 2003). The lamp fixture 10 is configured to include a reflector 133 behind the lamp tubes 13 that can optionally be configured to optimize the ratio of light spilled to the ambient relative to light illuminating the task materials.

The reflector 133 can be formed either by any of extrusion, bending of polished sheet metal, stamping or other means. More important than the forming means, the geometry of the reflector 133 can be readily optimized for each lamp tube 13 within the fixture (two are shown but as stated above the number and types of lamps may be readily varied and the reflector optimized to accommodate the variations).

All reflectors, regardless of their geometry, present a specular or mirror-like surface, which reflects light uniformly. When light strikes a specular surface, it is reflected at an angle equal to the angle of incidence (the angle at which it strikes the surface of the reflector relative to the normal or perpendicular to the surface). If light is an ideal point source and is located at the focus of a reflector 133 having a parabolic cross-section, all of the light will be redirected in parallel rays away from the reflector 133.

In practice, a reflector 133 having an elliptical profile have a much greater utility than the parabolic reflector and have a greater efficiency than reflectors having a semi-circular profile with the lamp tube 13 at its center. Elliptical reflectors also produce a beam profile that is relatively intense in the center and falling off in a controlled fashion as the a function of distance from the center. Additionally, because a fluorescent tube is not an ideal point source but rather a diffuse circular point source, the light exiting the reflector is advantageously defocused, tending to minimize glare at the work piece materials. An advantage of the inventive lamp fixture 10 is that it can readily accommodate interchangeable reflectors 133 with profiles selected based upon height above the work piece and a desired luminance ratio. Additionally, the selection of reflector 133 profile can be advantageously selected to harmonize with adjacent light fixtures 10 to cast a more even light on the work piece. The interchangeable reflector 133 allows further customization of the light fixture 10 to optimize the throw of light without the requiring additional lumens from the lamp tubes 13.

A further advantage of the light fixture 10 is its lens 17. The preferred embodiment is of an extruded Polycarbonate. Polycarbonate is a transparent amorphous thermoplastic which offers very high impact strength and high modulus of elasticity. Polycarbonate resins which are polyesters of carbonic acid and bisphenol A are available in various grades commercially under such trademarks as Lexan™ (General Electric), Merlon™ (Mobay Chemical), etc. The material has a 290° F. (145° C.) heat deflection temperature at 264 psi, absorbs very little moisture and resists acidic solutions. These properties, in addition to good electrical characteristics, make polycarbonate stock shapes an excellent choice for electrical applications. Its strength, impact resistance and transparency also make it an ideal material for certain transparent structural applications such as sight glasses and windows.

The lens 17 is configured as a fixed profile extrusion. Extrusion is a process used to create objects of a fixed cross-sectional profile. A material is pushed or drawn through a die of the desired cross-section. The two main advantages of this process over other manufacturing processes include its ability to create very complex cross-sections and to work materials that are brittle as the material only encounters compressive and shear stresses. By extruding the polycarbonate rather than casting it, the lens is formed with an excellent surface finish. Additionally, where prismatic surfaces are desired to further direct the light by refraction, extrusion will readily form such a prismatic lens 17. The resulting lens 17 is very efficient.

End caps 11 on opposing ends of the lens 17 tie the lens 17 and the housing 175 into a single mechanical unit. Polycarbonate is extraordinary durable. As the lens is tied to the housing 175, itself a beam, by the endcap 11, the resulting light fixture is durable and impact resistant. The otherwise vulnerable lamp tubes 13 are suspended securely within the cavity the lens 17 defines making the light fixture 10 extraordinarily well suited for the working environment. A common problem in the use of fluorescent lamps in a workplace is the movement of material into and out of the workplace. Fluorescent lamps are extraordinarily vulnerable to incursive injury. Generally this occurs in the course of tipping up materials.

When lamps are cold, some of the mercury in the lamp is in liquid form, but while the lamp is operating, or when the lamp is hot, most of the mercury is in a gaseous or vapor form. Mercury vapor is a highly toxic substance, with an “extreme” rating as a poison. Even in liquid form, contact with mercury is considered life-threatening or a “severe” risk to health. Mercury can cause severe respiratory tract damage, brain damage, kidney damage, central nervous system damage, and many other serious medical conditions even for extremely small doses. The lens 17 protects the lamp tubes 13 from incursive injury and liberation of mercury vapor from within the lamp tubes 13.

The endcaps 11 have a number of innovative features that lend utility to the light fixture 10. A wingbolt 177 (or alternatively a hex bolt 179) and lock washer 178 fastens the endcap 11 to the housing 175 and thereby to fix the lens in place with a biasing force against a gasket 173. Advantageously, the use of the wingbolt 177 makes the light fixture “hand serviceable” allowing the replacement of lamps without requiring a wrench.

Configured not only to mechanically tie the housing 175 to the lens 17, the endcap also serves to make suitable storage and transportation of the fixtures 10 readily achievable. A stacking tab 115 is set in opposed relation to a stacking hole 118 that allows the light fixtures 10 to be stacked in interlocking fashion as the stacking tab 115 mates with the stacking hole 118 on an adjacent light fixture 10. This stacking capability facilitates easy storage and further allows the light fixture 10, when stacked, to be strapped on palates for ready transport.

Further features of the endcap 11 include two hand hold holes 112 allowing the end cap 13 to serve as a handle for moving the light fixture 10 and, as importantly, for installing the light fixture 10. Having the handle at the extreme ends of the light fixture 10 gives the user the leverage to hold the light fixture 10 in place and to hold it steady with one hand while installing fasteners with the remaining hand.

A cable tie (also colloquially known as zip tie, zap strap, zip strip, wire tie, mouse belt, tie wrap, quick draw, or rat belt) is a type of fastener, especially for binding several electronic cables or wires together and to organize cables and wires. In its most popular form, a cable tie consists of a sturdy Nylon™ tape with an integrated gear rack, and on one end a ratchet within a small open case. Once the pointed tip of the cable tie has been pulled through the case and past the ratchet, it is prevented from being pulled back; the resulting loop may only be pulled tighter. Cable ties can be used to fasten the light fixture 10 to a pipe, a bulkhead, framing or other suitable fastening point. When used in tandem with the hand holes 112, hang holes 121 provide easy means for installation by a single user.

An additional means for fastening the light fixture 10 to overhead or to bulkheads is in flanges 124 extending from the endcap 11. Each of the flanges 124 defines an additional fastening hole 123. These flanges 124 have the additional advantage of being coplanar allowing more permanent installation of the light fixture 10 by use of lag screws or bolts into a surface for mounting.

In use, it is often advantageous to use more than a single light fixture 10 to suitably illuminate a workpiece or a large work area. To allow the ganging of these light fixtures 10, the light fixtures 10 are connected to AC power by means of a standard three-prong grounded plug. To power the light fixture 10, a supply cord 161 terminated by a male standard three-prong grounded plug. From the light fixture 10, a distribution cord 165 terminated at a female standard three-prong grounded plug. Both the supply cord 161 and the distribution cord 165 join the endcap 11 with a strain relief 163 fastened in cooperation with a nut 169. A fuse holder assembly 157 assembly protects the internal circuitry from damage due to current draw.

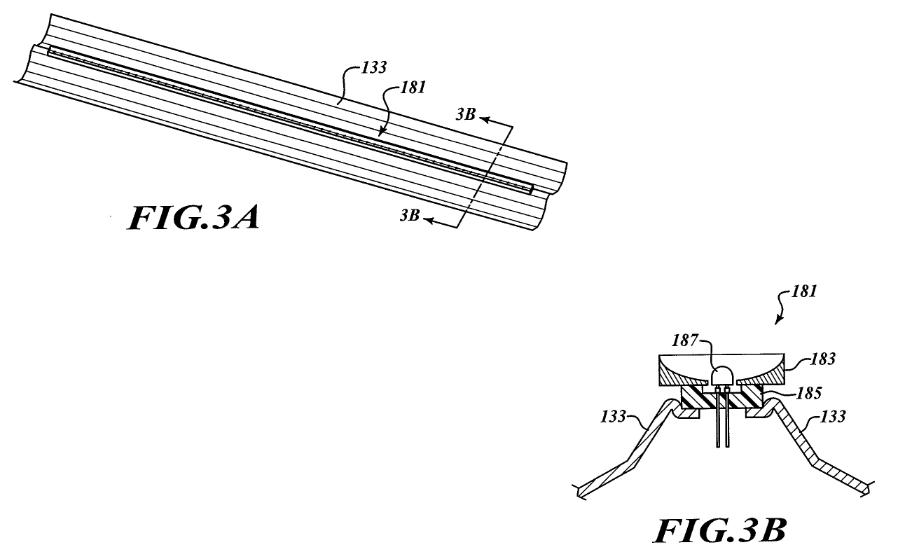

FIGS. 3A and 3B show installation of an optional LED track 181. The track is populated by a number of high output long wave-length Red LEDs 187 each situated in a reflector for optimal dispersion of red light. In a reaction that provides biological night vision, molecules of rhodopsin in the rods of the eye undergo a change in shape as light is absorbed by them. Rhodopsin is the chemical that allows night-vision, and is extremely sensitive to light. Exposed to a spectrum of light, the pigment immediately bleaches, and it takes about 30 minutes to regenerate fully, but most of the adaptation occurs within the first five or ten minutes in the dark. Rhodopsin in the human rods is less sensitive to the longer red wavelengths of light, so in many applications, the use of red light is helpful to preserve night vision as exposure to red light more slowly depletes the eye's rhodopsin stores in the rods than in full-spectrum light. For that reason, it is advantageous, in some settings to be able to selectively switch the light emanating from the work lamp fixture 10 between the emission from the fluorescent lamp tube 13 to the emission from the LEDs 187 by alternately directing current from the fluorescent lamp tube 13 to the LEDs 187.

Structurally, the LEDs 187 rest in an LED reflector 183, the LED reflectors 183 collectively formed into an elongate strip 181. In one embodiment, the strip 181 is held within apertures in the reflector 133 by a resilient base 185 inserted as a grommet into the reflector 133 to mechanically fix the strip 181 to the reflector 133 for use within the lamp fixture 10.

The LED reflectors 183 provide, as well an electrical conduit between the red LEDs 187 and a power supply, presumably a power supply working in cooperation with either of the electronic ballast or the backup battery. When suitably energized by the power supply, the red LEDs 187 will provide a red light through the polycarbonate lens 17, optimally used when the at least one fluorescent lamp tube 13 is not energized nor emitting light, thereby allowing the red LEDs 187 to advantageously provide light less likely to compromise the night vision of those working in proximity to the light fixture 10.

As has been described above, the light fixture 10 provides safe illumination in the workplace free from the threat of incursive injury. In an integrated unit, the light fixture 10 provides optimal light transmission, portability, power distribution, and battery backup in an impact resistant package. The lighting profile is customizable. The sealed integrity of the light fixture 10 is provided without compromising the performance in casting illumination.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A lamp fixture comprising:
an housing situated along a housing principal axis, the housing having a first housing end and a second housing end situated in opposed relation along the housing principle axis, the housing enclosing:
an electronic ballast in electrical connection with a power source and at least one pair of fluorescent lamp sockets, each of the at least one pair of sockets, being in opposed relation one to the other, to electrically connect the at least one fluorescent tubular lamp to the electronic ballast and mechanically connect and hold the at least one fluorescent tubular lamp in parallel to the housing principle axis;
a reflector situated between each of the at least one pair of fluorescent light sockets in a manner to reflect light emanating from the fluorescent tubular lamp out of the housing when the fluorescent tubular lamp is suitably energized from the electronic ballast through the sockets;
a polycarbonate lens tube to encompass the housing about the housing principle axis and to transmit the light emanating from the at least one tubular fluorescent lamp, open at first and second tube ends, the first and second tube ends being situated in opposed relation along the housing principle axis;
a first and a second endcap, the first endcap configured to join the first tube end to the first housing end; the second endcap configured to join the second tube end to the second housing end, thereby, when so joined, in cooperation with the lens tube and the housing to provide a light fixture for the at least one fluorescent tubular lamp.

2. The lamp fixture of claim 1, wherein the endcap is further configured to include:
a stacking tab extending from the endcap; and
wherein the endcap defines a stacking hole to receive the stacking tab from a second endcap to allow the stacking of the lamp fixture in a registered manner on a second like lamp fixture.

3. The lamp fixture of claim 1, wherein the electronic ballast includes, in electrical connection a backup battery to selectably energize the fluorescent lamp.

4. The lamp fixture of claim 1, wherein the electronic ballast includes, in electrical connection, a mating cord having a male plug for electrically connecting to an external power source.

5. The lamp fixture of claim 4, wherein the electronic ballast further includes a mating cord having a female plug for electrically connecting a second like lamp fixture to the lamp fixture for energizing the second lamp fixture.

6. The lamp fixture of claim 1, wherein the first endcap being configured to join the first tube end to the first housing end; the second endcap being configured to join the second tube end to the second housing end, each include a hand-turnable nut for disassembly of the lamp fixture.

7. The lamp fixture of claim 1, wherein the hand-turnable nut is a wingnut.

8. The lamp fixture of claim 1, wherein the reflector defines an LED reflector assembly comprising:
an LED strip including a plurality of LED lamps configured to emit a red light when energized; and
an LED reflector configured to direct the red light through the polycarbonate lens tube and to fixedly hold the LED strip to the reflector and to connect the LED lamps to a power supply.

9. A method of hand-assembling a lamp fixture for at least one fluorescent lamp tube, the method comprising:
providing a housing situated along a housing principal axis, the housing having a first housing end and a second housing end situated in opposed relation along the housing principle axis, the housing enclosing:
an electronic ballast in electrical connection with a power source and at least one pair of fluorescent lamp sockets, each of the at least one pair of sockets, being in opposed relation one to the other, to electrically connect the at least one fluorescent tubular lamp to the electronic ballast and mechanically connect and hold the at least one fluorescent tubular lamp in parallel to the housing principle axis;
a reflector situated between each of the at least one pair of fluorescent light sockets in a manner to reflect light emanating from the at least one fluorescent tubular lamp out of the housing when the fluorescent tubular lamp is suitably energized from the electronic ballast through the sockets;
inserting at least one fluorescent lamp tube into the at least one pair of fluorescent lamp sockets to establish an electrical connection to the at least one fluorescent tubular lamp;
inserting the housing with the at least one fluorescent lamp tube into a polycarbonate lens tube to encompass the housing about the housing principle axis and the lens tube to transmit the light emanating from the at least one tubular fluorescent lamp, the lens tube open at first and second tube ends, the first and second tube ends being situated in opposed relation along the housing principle axis;
affixing a first and a second endcap to the housing by means of a first and second hand-turnable nut, the first endcap configured to join the first tube end to the first housing end; the second endcap configured to join the second tube end to the second housing end, thereby, when so joined, in cooperation with the lens tube and the housing to provide a light fixture for the at least one fluorescent tubular lamp.

10. The method of claim 9, wherein the endcap is further configured to include:
a stacking tab extending from the endcap; and
wherein the endcap defines a stacking hole to receive the stacking tab from a second endcap to allow the stacking of the lamp fixture in a registered manner on a second like lamp fixture.

11. The method of claim 9, wherein the electronic ballast includes, in electrical connection a backup battery to selectably energize the fluorescent lamp.

12. The method of claim 9, wherein the electronic ballast includes, in electrical connection, a mating cord having a male plug for electrically connecting to an external power source.

13. The method of claim 12, wherein the electronic ballast further includes a mating cord having a female plug for electrically connecting a second like lamp fixture to the lamp fixture for energizing the second lamp fixture.

14. The method of claim 9, wherein the first endcap being configured to join the first tube end to the first housing end; the second endcap being configured to join the second tube end to the second housing end, each include a hand-turnable nut for disassembly of the lamp fixture.

15. The method of claim 9, wherein the hand-turnable nut is a wingnut.

16. The method of claim 9, wherein providing housing includes providing the reflector, and wherein the reflector defines an LED reflector assembly comprising:
an LED strip including a plurality of LED lamps configured to emit a red light when energized; and
an LED reflector configured to direct the red light through the polycarbonate lens tube and to fixedly hold the LED strip to the reflector and to connect the LED lamps to a power supply.
